(19) United States
(12) Patent Application Publication
(10) Pub. No.: US 2011/0292096 A1
(43) Pub. Date: Dec. 1, 2011

(54) LIQUID CRYSTAL DISPLAY DEVICE

(75) Inventor: Kohichi Ohhara, Osaka (JP)

(73) Assignee: SHARP KABUSHIKI KAISHA, Osaka (JP)

(21) Appl. No.: 13/147,907

(22) PCT Filed: Nov. 20, 2009
(86) PCT No.: PCT/JP2009/069704

§ 371 Date: Aug. 4, 2011

(30) Foreign Application Priority Data
Feb. 5, 2009 (JP) 2009-025294

(51) Int. Cl. G09G 5/10

(52) U.S. Cl. 345/690

(57) ABSTRACT

A normally black liquid crystal display device of the present invention is provided with a liquid crystal display panel 11 having two or more sets of pixel electrode groups, a light guide plate 13 arranged to overlap the liquid crystal display panel, and a light source 12 arranged on the side of the light guide plate along one side thereof. A value obtained by subtracting a voltage applied to liquid crystal through a blue (B) pixel electrode constituting a set of pixel electrode group closer to the light source from a voltage applied to liquid crystal through a blue (B) pixel electrode constituting the set of pixel electrode group farther from the light source is larger than a value obtained by subtracting a voltage applied to liquid crystal through a green (G) pixel electrode constituting the set of pixel electrode group closer to the light source from a voltage applied to liquid crystal through a green (G) pixel electrode constituting the set of pixel electrode group farther from the light source, and is larger than a value obtained by subtracting a voltage applied to liquid crystal through a red (R) pixel electrode constituting the set of pixel electrode group closer to the light source from a voltage applied to liquid crystal through a red (R) pixel electrode constituting the set of pixel electrode group farther from the light source. Thus, according to the present invention, a sidelight-type liquid crystal display device, in which occurrence of yellow tinges on only a part of the liquid crystal display panel is suppressed and chromaticity uniformity is improved, can be obtained.

### TECHNICAL FIELD

The present invention relates to a liquid crystal display device, and more particularly, to a sidelight-type liquid crystal display device that has a light guide plate and that uses light guided from the light guide plate as display light.

### BACKGROUND ART

Liquid crystal display devices are widely used in televisions, personal computer monitors, portable device monitors and the like because they are display devices that can be driven using low power and easily made light and thin. A conventional liquid crystal display device is provided with a liquid crystal display panel having a pair of substrates and a liquid crystal layer disposed between the pair of substrates, a pair of polarizing plates that are respectively arranged on both outer surfaces of the liquid crystal display panel, a backlight that emits display light, and the like.

Liquid crystal display devices control the refractive index of light transmitted through a liquid crystal layer by controlling a voltage applied to the liquid crystal layer, and control display by either transmitting or blocking light using a pair of polarizing plates. The voltage applied to the liquid crystal layer is controlled by a peripheral circuit arranged around the liquid crystal display panel (see Patent Document 1, for example).

According to a configuration of an example in Patent Document 1, backlight luminance is predicted based on image data, and chromaticity shifts are corrected by correcting signal values of RGB using a γ table for color correction. However, because such a correction method calculates a chromaticity shift value based on an inputted signal value of image data and luminance data of the backlight, a circuit for calculating chromaticity and a frame memory for temporarily storing image data need to be provided, and the costs increase as the circuit size increases. Furthermore, because the chromaticity shift value is obtained by calculation, the most appropriate chromaticity adjustment may not be performed due to a calculation error.

In order to address these issues, there has been disclosed a method using a liquid crystal display device that includes a backlight disposed on the back side of a liquid crystal display unit, a backlight driving means that supplies a voltage to the backlight, and a primary storage means that temporarily stores data for γ correction for each color (see Patent Document 2, for example).

According to a configuration of an example in Patent Document 2, every time the amount of the current applied to the backlight is changed, red (R), green (G) and blue (B) γ table data corresponding to the current amount applied to the backlight are rewritten using an updating means that updates the respective γ table data in accordance with changes in a luminance adjusting signal representing a voltage applied to the backlight by the backlight driving means, thereby correcting a voltage applied to liquid crystal by a γ correction in the γ table data and setting chromaticity of the liquid crystal display unit at the most appropriate value.

### RELATED ART DOCUMENTS

### Patent Documents

Patent Document 1: Japanese Patent Application Laid-Open Publication No. 2002-99250

Patent Document 2: Japanese Patent Application Laid-Open Publication No. 2008-76687

### SUMMARY OF THE INVENTION

### Problems to be Solved by the Invention

While conducting studies to improve the quality of a sidelight-type display panel provided with a light guide plate, the inventor of the present invention found that a part of the display panel had yellow tinges and that tinges in areas of the light guide plate farther from the light source had a more intense shade of yellow.

According to a configuration of an example in Patent document 2, the amount of the current applied to the backlight is adjusted according to changes in a luminance adjusting signal of the backlight, and although tinges of the display panel can be corrected at one time in the overall display panel, the problem of chromaticity variance that depends on area within the display panel cannot be solved because there is no setting to individually adjust tinges in the respective areas based on a distance from the light source.

The present invention seeks to address the issues above. The purpose of the present invention is to provide a liquid crystal display device that is adjusted to have chromaticity uniformity on a display surface.

### Means for Solving the Problems

The inventor of the present invention conducted various studies on causes of yellow tinges on a part of a display panel and noticed that yellow tinges on a display panel were seen in a sidelight-type liquid crystal display device having a light guide plate and that the farther an area was from the light source, the more intense the tinges appeared in the area. In addition, the inventor found that colors can be displayed evenly in any area of the display panel, regardless of the distance from the light source, by differentiating the amount of a voltage applied to liquid crystal through the respective pixel electrodes constituting a set of pixel electrode groups closer to the light source and the amount of a voltage applied to liquid crystal through the respective pixel electrodes constituting a set of pixel electrode groups farther from the light source such that the chromaticity inclination of light from the backlight due to a difference in distance from the light source (optical path length of light passing in a light guide plate cancels the chromaticity inclination of transmittance of the display panel due to a difference in voltage applied to liquid crystal). This way, blue is enhanced in areas where yellow tinges appear, offsetting the yellow of the tinges with the blue. The inventor, thus, concluded that the problems above can be successfully addressed and reached the present invention.

Thus, the present invention is a normally black liquid crystal display device that is provided with a liquid crystal display panel having two or more sets of pixel electrode groups each including a red pixel electrode, a green pixel electrode, and a blue pixel electrode, a light guide plate arranged to overlap the liquid crystal display panel, and a light source arranged on a side of the light guide plate along one side thereof, wherein, of the aforementioned two or more sets of pixel electrode groups, a value obtained by subtracting a voltage applied to liquid crystal through a blue pixel electrode constituting a set of pixel electrode group closer to the light source from a voltage applied to liquid crystal through a blue pixel electrode constituting a set of pixel electrode group farther from the light source is larger than a value obtained by subtracting a voltage applied to liquid crystal through a green pixel electrode constituting the set of pixel electrode group closer to the light source from a voltage applied to liquid crystal through a green pixel electrode constituting the set of pixel electrode group farther from the light source, and is larger than a value obtained by subtracting a voltage applied to liquid crystal through a red pixel electrode constituting the set of pixel electrode group closer to the light source from a voltage applied to liquid crystal through a red pixel electrode constituting the set of pixel electrode group farther from the light source (hereinafter may be referred to as a first liquid crystal display device of the present invention).

The present invention is also a normally white liquid crystal display device that is provided with a liquid crystal display panel having two or more sets of pixel electrode groups each including a red pixel electrode, a green pixel electrode, and a blue pixel electrode, a light guide plate arranged to overlap the liquid crystal display panel and a light source arranged on a side of the light guide plate along one side thereof, wherein, of the aforementioned two or more sets of pixel electrode groups, a value obtained by subtracting a voltage applied to liquid crystal through a blue pixel electrode constituting a set of pixel electrode group closer to the light source from a voltage applied to liquid crystal through a blue pixel electrode constituting the set of pixel electrode group farther from the light source is smaller than a value obtained by subtracting a voltage applied to liquid crystal through a green pixel electrode constituting the set of pixel electrode group closer to the light source from a voltage applied to liquid crystal through a green pixel electrode constituting the set of pixel electrode group farther from the light source, and is smaller than a value obtained by subtracting a voltage applied to liquid crystal through a red pixel electrode constituting the set of pixel electrode group closer to the light source from a voltage applied to liquid crystal through a red pixel electrode constituting the set of pixel electrode group farther from the light source (hereinafter may be referred to as a second liquid crystal display device of the present invention).

The first and second liquid crystal display devices of the present invention are respectively provided with a liquid crystal display panel having two or more sets of pixel electrode groups each including a red pixel electrode, a green pixel electrode, and a blue pixel electrode. In this specification, a “red pixel electrode” is a pixel electrode that is used to display red, such as, for example, a pixel electrode arranged at a place overlapping a red color filter. Similarly, a “green pixel electrode” is a pixel electrode that is used to display green, such as, for example, a pixel electrode arranged at a place overlapping a green color filter. Similarly, a “blue pixel electrode” is a pixel electrode that is used to display blue, such as, for example, a pixel electrode arranged at a place overlapping a blue color filter. Furthermore, in this specification, “red” is a wavelength component whose dominant wavelength is within the range of 650-780 nm, and “green” is a wavelength component whose dominant wavelength is within the range of 510-570 nm, and “blue” is a wavelength component whose dominant wavelength is within the range of 470-510 nm. Furthermore, the aforementioned set of pixel electrode group may include cyan (C), magenta (M) and yellow (Y) pixel electrodes and the like in addition to red, green and blue, and color filters of respective colors may be arranged at places overlapping these pixel electrodes.

In the first and the second liquid crystal display devices of the present invention, an additive color mixing method by which a displayed color is set depending on the balance of the combination of three colors including red, green and blue, is used. The amount of light transmitted through liquid crystal molecules in the liquid crystal layer is adjusted according to the strength of the electric field formed in the liquid crystal layer. As a result, desired light with a properly balanced combination of three colors including red, green and blue is emitted from the liquid crystal display panel. In this specification, “a liquid crystal display panel” is a display panel that controls display utilizing the properties of liquid crystal molecules, such as, for example, a display panel having a configuration provided with a pair of substrates and a liquid crystal layer arranged between the aforementioned pair of substrates in addition to having an optical member, such as a polarizing plate or the like, attached to the aforementioned pair of substrates on the opposite side from the liquid crystal layer.

The first and second liquid crystal display devices of the present invention are respectively provided with a light guide plate arranged to overlap a liquid crystal display panel and a light source arranged on the side of the light guide plate along one side thereof. Thus, the liquid crystal display device of the present invention is a sidelight (edge light)-type liquid crystal display device having a light guide plate, and light emitted from the light source becomes a planar light beam and is guided to the liquid crystal display panel by the light guide plate. When the aforementioned light source is a linear light source, it is arranged so that the longitudinal axis of the linear light source runs along one side of the light guide plate. When the aforementioned light source is a point light source, a plurality of light sources are arranged in a row. The number of the linear light sources and the point light sources is not particularly limited. When the aforementioned light source is a point light source, a plurality of point light sources are preferably arranged in a straight line from the standpoint of light uniformity. However, the arrangement is not particularly limited as long as they are arranged in a row on the side of the light guide plate, and can be in a zigzag pattern, for example.

The first liquid crystal display device of the present invention is normally black. In this specification, “normally black” is a display mode that displays black when a voltage applied to liquid crystal is below a threshold and displays white when a voltage applied to liquid crystal is equal to or higher than the threshold. A normally black liquid crystal display device has a characteristic that transmittance increases further as a voltage applied to liquid crystal increases.

The second liquid crystal display device of the present invention is normally white. In this specification, “normally white” is a display mode that displays white when a voltage applied to liquid crystal is below a threshold and displays black when a voltage applied to liquid crystal is equal to or higher than the threshold. A normally white liquid crystal display device has a characteristic that transmittance decreases as a voltage applied to liquid crystal increases.

In the first liquid crystal display device of the present invention, of the aforementioned two or more sets of pixel electrode groups, a value obtained by subtracting a voltage applied to liquid crystal through a blue pixel electrode constituting a set of pixel electrode group closer to the light source from a voltage applied to liquid crystal through a blue pixel electrode constituting the set of pixel electrode group farther from the light source is larger than a value obtained by subtracting a voltage applied to liquid crystal through a green pixel electrode constituting the set of pixel electrode group closer to the light source from a voltage applied to liquid crystal through a green pixel electrode constituting the set of pixel electrode group farther from the light source, and is larger than a value obtained by subtracting a voltage applied to liquid crystal through a red pixel electrode constituting the set of pixel electrode group closer to the light source from a voltage applied to liquid crystal through a red pixel electrode constituting the set of pixel electrode group farther from the light source. In addition, the aforementioned set of pixel electrode group closer to the light source may hereinafter be referred to as “light entry side pixel electrode group,” and the aforementioned set of pixel electrode group farther from the light source may hereinafter be referred to as “light exit side pixel electrode group.”

In sidelight-type liquid crystal display devices having a light guide plate, the farther an area is from the light source, the more susceptible it becomes to have yellow tinges on the display panel. Therefore, chromaticity uniformity of the overall display can be improved by enhancing blue, which is the complementary color of yellow, more than other colors in areas farther from the light source. The higher a voltage applied to liquid crystal becomes, the greater the inclination of liquid crystal molecules included in the liquid crystal layer becomes, increasing transmittance of light in a normally black mode. Meanwhile, in the normally black mode, the lower a voltage applied to liquid crystal becomes, the smaller the inclination of liquid crystal molecules becomes, decreasing transmittance of light.

In the first liquid crystal display device of the present invention, a desired hue is displayed by adjusting the balance of the respective colors. Therefore, in order to enhance blue in an area farther from the light source, an increased amount at a blue pixel electrode needs to be higher than that for pixel electrodes other than the blue pixel electrode (the red and green pixel electrodes, for example) among differences between the light entry side and the light exit side using the light entry side as a reference. Here, an increase is a concept that includes not only positive, but also negative, and a negative increase means a so-called decrease. In addition, an amount of increase does not mean a so-called absolute value, and between a positive increase and a negative increase, for example, the positive increase has a larger amount of increase.

The difference between the voltages applied to liquid crystal through pixel electrodes other than a blue pixel electrode on the light entry side and on the light exit side is not particularly limited. Therefore, as for the amount of the voltage applied to liquid crystal through pixel electrodes other than a blue pixel electrode, when comparing the light entry side and the light exit side, voltages applied on the light entry side and on the light exit side may be the same, or a voltage applied on the light exit side may be lower than a voltage applied on the light entry side, or a voltage applied on the light exit side may be higher than a voltage applied on the light entry side within a range not exceeding the amount of increase in voltage applied to liquid crystal through a blue pixel electrode.

In the second liquid crystal display device of the present invention, of the aforementioned two or more sets of pixel electrode groups, a value obtained by subtracting a voltage applied to liquid crystal through a blue pixel electrode constituting a set of pixel electrode group closer to the light source from a voltage applied to liquid crystal through a blue pixel electrode constituting a set of pixel electrode group farther from the light source is smaller than a value obtained by subtracting a voltage applied to liquid crystal through a green pixel electrode constituting the set of pixel electrode group closer to the light source from a voltage applied to liquid crystal through a green pixel electrode constituting the set of pixel electrode group farther from the light source, and is smaller than a value obtained by subtracting a voltage applied to liquid crystal through a red pixel electrode constituting the set of pixel electrode group closer to the light source from a voltage applied to liquid crystal through a red pixel electrode constituting the set of pixel electrode group farther from the light source.

As described above, the higher the amount of a voltage applied to liquid crystal becomes, the greater the inclination of liquid crystal molecules included in the liquid crystal layer becomes. Therefore, transmittance of light is decreased in a normally white mode. Meanwhile, in the normally white mode, the lower the amount of a voltage applied to liquid crystal becomes, the smaller the inclination of liquid crystal molecules included in the liquid crystal layer becomes, increasing transmittance of light.

In a manner similar to the first liquid crystal display device of the present invention, in the second liquid crystal display device of the present invention, a desired hue is displayed by adjusting the balance of the respective colors. Therefore, in order to enhance blue more than the other colors in an area farther from the light source, the decreased amount (negative increase) at a blue pixel electrode needs to be higher than that for pixel electrodes other than the blue pixel electrode (the red and the green pixel electrodes, for example) among differences between the light entry side and the light exit side using the light entry side as a reference. Here, a decrease is a concept that includes not only positive, but also negative, and a negative decrease means a so-called increase. In addition, an amount of decrease does not mean a so-called absolute value, and between a positive decrease and a negative decrease, for example, the positive decrease has a larger amount of decrease.

The difference between the voltages applied to liquid crystal through pixel electrodes other than the blue pixel electrode on the light entry side and on the light exit side is not particularly limited. Therefore, as for the amount of the voltage applied to liquid crystal through pixel electrodes other than the blue pixel electrode, when comparing the light entry side and the light exit side, voltages applied on the light entry side and on the light exit side may be the same, or a voltage applied on the light exit side may be higher than a voltage applied on the light entry side, or a voltage applied on the light exit side may be lower than a voltage applied on the light entry side within a range not exceeding the amount of decrease in voltage applied to liquid crystal through the blue electrode.

As examples of arrangement patterns of the aforementioned set of pixel electrode group, there are a stripe arrangement, a mosaic arrangement, a delta arrangement, a PenTile arrangement, and the like. The stripe arrangement is an arrangement where the pixel electrodes of the same color are arranged in rows in a direction of a row or a column. The order in which the colors of red (R), green (G) and blue (B) are arranged is not particularly limited. The mosaic arrangement is an arrangement where red (R), green (G) and blue (B) pixel electrodes are alternately and repeatedly arranged in a fixed order in a direction of a row or a column. The order in which the colors of red (R), green (G) and blue (B) are arranged is not particularly limited. Furthermore, when the aforementioned mosaic arrangement is used and the respective pixel electrodes are arranged in a matrix, the pixel electrodes of the same color are arranged in a diagonal direction. The delta arrangement is an arrangement where three pixel electrodes of red (R), green (G), and blue (B) are arranged to form a triangle. The order in which the colors of red (R), green (G) and blue (B) are arranged is not particularly limited. The PenTile arrangement is an arrangement where four pixel electrodes of red (R), green (G1), blue (B), and green (G2) pixel electrodes are arranged as a set. The order in which the respective colors are arranged in is not particularly limited, and green (G1) and green (G2) may not necessarily be the same color.

Of the aforementioned two or more sets of pixel electrode groups, criteria for judging whether they are “closer to the light source” or “farther from the light source” are explained below. First, in terms of determining an arrangement of the light source, the light source in the present invention is assumed to be arranged on the side of the light guide plate along one side thereof. Therefore, when the aforementioned light source is a linear light source, the longitudinal axis of the linear light source becomes the reference line for determining the distance from the light source. When the aforementioned light source is a point light source, a virtual line that is formed by connecting a plurality of point light sources becomes the reference line for determining the distance from the light source. Furthermore, when point light sources are not arranged in a straight line and are arranged in a zigzag pattern, for example, a straight virtual line that is approximately formed by connecting a plurality of point light sources becomes the reference line for determining the distance from the light source.

Whether the aforementioned set of pixel electrode groups is “close” or “far” is determined based on a distance from the aforementioned reference line of the light source. In terms of determining the arrangement of the set of pixel electrode groups, the point at the center of the pixel area constituted of the set of pixel electrode group becomes the reference point. Whether the aforementioned set of pixel electrode group is “close” or “far” is determined based on a distance between the respective reference points of the respective pixel electrode group and the aforementioned reference line of the light source.

As a configuration of a liquid crystal display device of the present invention, as long as these components are included as necessary components, the configuration may or may not include other components, and is not particularly limited.

In a liquid crystal display device of the present invention, the number of the aforementioned two or more sets of pixel electrode groups is not particularly limited. However, as a rule, the higher the number of sets of the aforementioned two or more sets of pixel electrode groups is, the more effectively chromaticity uniformity improves. In terms of the number of sets of the aforementioned two or more sets of pixel electrode groups, at least half of the all pixel electrode groups preferably meet the requirements of the present invention. As a result, effects of chromaticity uniformity can be sufficiently obtained.

More preferably, the aforementioned two or more sets of pixel electrode groups are essentially all of the pixel electrode groups. Here, “essentially all of the pixel electrode groups” mean that at least 90% of the pixel electrode groups of the abovementioned liquid crystal display device are pixel electrode groups that meet the requirements of the present invention. One set of the aforementioned pixel electrode group is constituted of red (R), green (G), and blue (B) pixel electrodes, and one pixel electrode group corresponds to one pixel. In addition, one pixel electrode corresponds to one subpixel. The number of pixels (resolution) provided in a liquid crystal display device of the present invention is not particularly limited.

The aforementioned set of pixel electrode group closer to the light source preferably is the closest set of pixel electrode groups to the light source, and the aforementioned set of pixel electrode group farther from the light source preferably is the farthest set of pixel electrode groups from the light source. For the set of pixel electrode group closer to the light source and the set of pixel electrode group farther from the light source, the longer the distance between these pixel electrode groups is, the greater the difference in chromaticity between corresponding areas becomes. Therefore, because the difference in chromaticity becomes the greatest between the closest set of pixel electrode group to the light source and the farthest set of pixel electrode group from the light source, effects of chromaticity uniformity can be obtained most effectively by using the closest set of pixel electrode groups to the light source and the farthest set of pixel electrode groups from the light source as the two or more sets of pixel electrode groups to which the present invention is applied. In addition, this configuration is preferable in terms of essentially all of the pixel electrode groups being able to be set to meet the requirements of the present invention by using a linear interpolation method explained below.

The aforementioned liquid crystal display device is preferably provided with a peripheral circuit that drives a liquid crystal display panel, and the aforementioned peripheral circuit is preferably provided with a storage medium having a plurality of γ tables including a first γ table that controls the amount of a voltage applied to liquid crystal through the respective pixel electrodes constituting a set of pixel electrode group closer to the light source and a second γ table that controls the amount of a voltage applied to liquid crystal through the respective pixel electrodes constituting a set of pixel electrode group farther from the light source. In this specification, a γ table is a data table that stores a γ value representing the transmittance values for input signal levels, and in the aforementioned second γ table, the relation between voltages applied to liquid crystal and gradation values is made differently by the respective colors. A required voltage to obtain a desired gradation can be applied to appropriate areas of the liquid crystal layer through the respective pixel electrodes by providing γ tables as a drive control means for pixel electrodes.

The aforementioned plurality of γ tables are preferably only the first and second γ tables. A liquid crystal display device of the present invention requires a configuration having two or more sets of pixel electrode groups. By limiting the number of γ tables provided for sets of pixel electrode groups to only two, the effect of the present invention can be obtained using a minimum storage area.

A voltage applied to liquid crystal through the respective pixel electrodes constituting a middle pixel electrode group located between the aforementioned sets of pixel electrode group closer to the light source and the aforementioned set of pixel electrode group farther from the light source preferably is calculated by a linear interpolation from the first and second γ tables. Appropriate voltages can be applied to many pixel electrode groups using a small storage area by calculating the voltages needed to be applied to liquid crystal through the rest of the pixel electrode groups based on the first and second γ tables. In addition, according to the linear interpolation method, appropriate voltages can be applied to essentially all of the pixel electrode groups located between the set of pixel electrode group that is the subject of the first γ table and the set of pixel electrode group that is the subject of the second γ table. Furthermore, as described above, by applying the configuration in which the aforementioned set of pixel electrode group closer to the light source is the closest set of pixel electrode group to the light source and the aforementioned set of pixel electrode group farther from the light source is the farthest set of pixel electrode groups from the light source to this configuration, chromaticity can be adjusted through essentially all of the pixel electrode groups, and a high level of uniformity improvement can be achieved.

### Effects of the Invention

According to the present invention, a sidelight-type liquid crystal display device that prevents an occurrence of yellow tinges on a part of a display panel and that has improved chromaticity uniformity can be obtained.

### BRIEF DESCRIPTION OF THE DRAWINGS

FIG. 1 is a cross-sectional schematic view of a liquid crystal display device according to Embodiment 1.

FIG. 2 is a schematic plan view of an LCD panel provided in a liquid crystal display device according to Embodiment 1.

FIG. 3 is a graph showing the relation between voltages applied to liquid crystal by pixel electrodes (voltages applied to liquid crystal) and gradation values for expressing gradation in a liquid crystal display device according to Embodiment 1, and shows the light entry side of the liquid crystal display panel.

FIG. 4 is a graph showing the relation between voltages applied to liquid crystal by pixel electrodes (voltages applied to liquid crystal) and gradation values for expressing gradation in a liquid crystal display device according to Embodiment 1, and shows the light exit side of the liquid crystal display panel.

FIG. 5 is a graph showing the relation between voltages applied to liquid crystal and the transmittance of light through a liquid crystal display panel in a normally black liquid crystal display device.

FIG. 6 is a block diagram showing signal processing performed by a peripheral circuit of a liquid crystal display device according to Embodiment 1.

FIG. 7 is a cross-sectional schematic view of a liquid crystal display device according to Embodiment 2.

FIG. 8 is a schematic plan view of an LCD panel provided in a liquid crystal display device according to Embodiment 2.

FIG. 9 is a graph showing the relation between voltages applied to liquid crystal and the transmittance of light through a liquid crystal display panel in a normally white liquid crystal display device.

### DETAILED DESCRIPTION OF EMBODIMENTS

With the embodiments given below, the present invention is explained in more detail with reference to the figures. However, the present invention is not limited to these embodiments.

### Embodiment 1

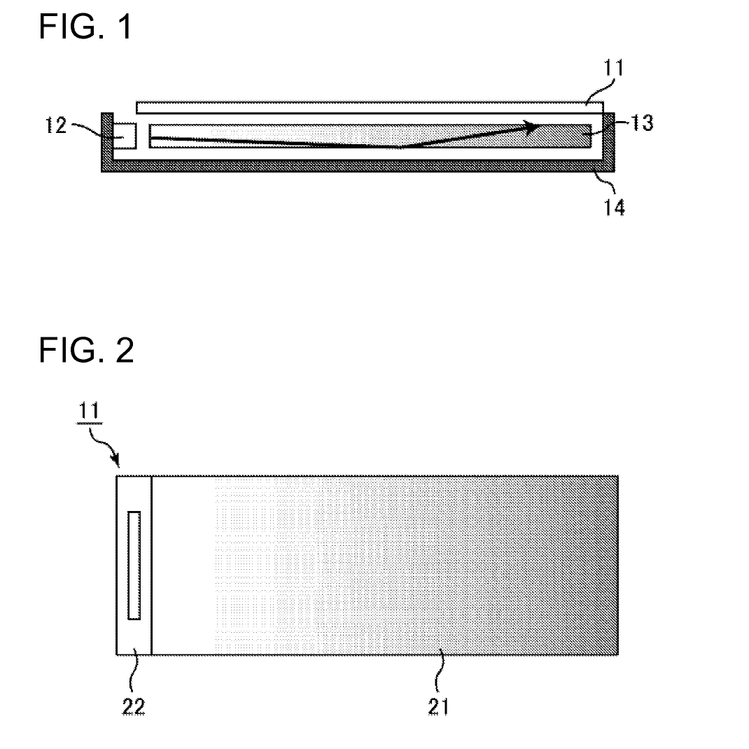

A liquid crystal display device according to Embodiment 1 is a first liquid crystal display device of the present invention that is normally black. FIG. 1 is a cross-sectional schematic view of the liquid crystal display device according to Embodiment 1. As shown in FIG. 1, the liquid crystal display device according to Embodiment 1 is provided with a liquid crystal display (LCD) panel 11, a light source 12, a light guide plate 13 and a frame 14 that surrounds each of the members constituting the liquid crystal display device. The liquid crystal display device of Embodiment 1 is a sidelight (edge light)-type liquid crystal display device because it is provided with a light guide plate.

The LCD panel 11 and the light guide plate 13 are arranged to overlap each other, and the light source 12 is arranged on the side of the light guide plate 13. Light (black arrow) emitted from the light source 12 first enters the light guide plate 13 from the side of the light guide plate 13, and is either reflected, refracted or diffused by a structural pattern provided on the light guide plate 13, and is emitted as planar light from the main surface side of the light guide plate 13 towards the liquid crystal display panel 11. Examples of the light source 12 include LED (Light Emitting Diode), CCFL (Cold Cathode Fluorescent Lamp), OEL (Organic Electro-luminescence) and the like. On the light guide plate, an optical sheet such as a diffusion sheet, a prism sheet or the like may be arranged.

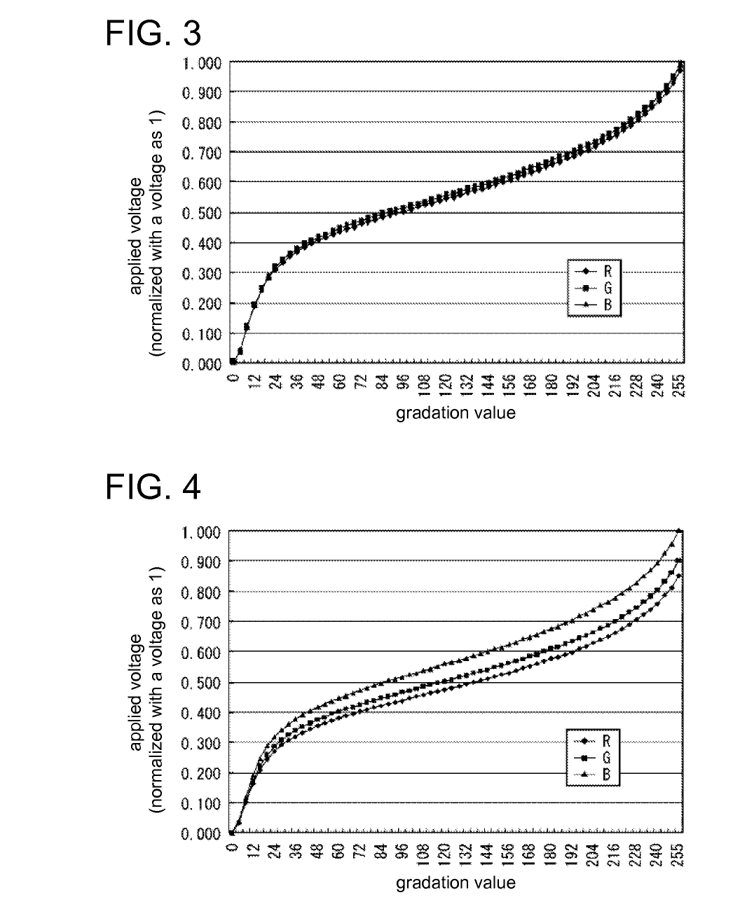

FIG. 2 is a schematic plan view of the LCD panel provided in the liquid crystal display device according to Embodiment 1. As shown in FIG. 2, the LCD panel 11 is constituted of a display unit 21 constituting a display screen and a peripheral circuit unit 22 for controlling drive of the display unit 21. The light source 12 is located below a side of the LCD panel 11 on the side the peripheral circuit 22 is located. Therefore, of the display unit 21 of the LCD panel, the side closer to the peripheral circuit unit 22 is the light entry side, and the side farther from the peripheral circuit unit 22 is the light exit side.

As an example of the LCD panel 11, there is a configuration having a pair of substrates and a liquid crystal layer with the liquid crystal layer disposed between the aforementioned pair of substrates. Insulating substrates such as glass substrates and the like can be used as the aforementioned pair of substrates. As a method of applying a voltage to the aforementioned liquid crystal layer, there is a method where a pair of electrodes are respectively arranged on the two glass substrates on the surfaces facing each other (liquid crystal layer side) and an electric field that runs across the liquid crystal layer is formed by applying a drive voltage to the respective electrodes. Here, the electrodes that were formed by dividing into a plurality of units are called pixel electrodes, and an electrode facing the pixel electrodes is called an opposite electrode. As driving methods of control for such provision of electrodes on both substrates of a pair of substrates, a VA (Vertical Alignment) mode, a TN (Twisted Nematic) mode and the like can be used. Also, instead of arranging electrodes on both substrates of the pair of substrates as described above, a method where a pair of comb-shaped electrodes facing each other are arranged on only one substrate of a pair of substrates and an electric field is formed in a lateral direction in a liquid crystal layer may be used. As a driving method of control for such an electrode arrangement, an IPS (In-plane Switching) mode can be used.

A liquid crystal display device according to Embodiment 1 is normally black. On each substrate of the aforementioned pair of substrates, a polarizing plate is arranged on the opposite side from the liquid crystal layer side. In other words, a pair of polarizing plates are arranged to face each other. As a polarizing plate, a polarizing plate that includes a polarizing film that can transmit, out of natural light, only polarized light that oscillates in a certain direction (polarizing axis direction) and a protective film that is disposed on one side or both sides of the aforementioned polarizing film to protect the polarizing film can be used, for example. As a polarizing film, a film such as a PVA (Polyvinyl Alcohol) film that has absorbed an iodine complex or a dichroic pigment can be used. As a protective film, a TAC (Triacetyl Cellulose) film or the like can be used. On the polarizing plate, a retardation film such as a λ/4 plate, λ/2 plate or the like may be attached as needed. The liquid crystal display device can be made normally black in a VA mode, an IPS mode or the like by adjusting polarizing axes that are provided respectively in the aforementioned pair of polarizing plates to form a right angle to each other (crossed Nicols state). Furthermore, the liquid crystal display device can be normally black in a TN mode by adjusting the polarizing axes that are provided respectively in the aforementioned pair of polarizing plates to be parallel to each other (parallel Nicols state).

Shades of white and black shown in FIGS. 1 and 2 respectively show yellow tinges on the LCD panel 11 when voltages applied to liquid crystal are not adjusted by the present invention. Darker parts are areas with more intense yellow tinges. As shown in FIGS. 1 and 2, yellow tinges on the LCD panel 11 gradually become more intense from the light entry side to the light exit side, and the farther an area is from the light source 12, the more intense the yellow tinges in the area become. The reason for such a chromaticity shift is that materials of the polarizing plate 13 have properties to absorb light on the short wavelength (blue wavelength) side more than light on the long wavelength (red wavelength) side, and in an area farther from the light source 12, light on the short wavelength side is absorbed more. Examples of materials used to make the light guide plate 13 are polycarbonate and acrylic resins, and both of them have the abovementioned light absorbing properties.

FIGS. 3 and 4 are graphs showing the relationship between voltages applied to liquid crystal by pixel electrodes (voltage applied to liquid crystal) and gradation values for expressing gradation in the liquid crystal display device according to Embodiment 1. FIG. 3 shows a set of pixel electrode group on the light entry side of the liquid crystal display panel, and FIG. 4 shows a set of pixel electrode group on the light exit side of the light crystal display panel. As shown in FIG. 3, on the light entry side of the liquid crystal display panel, gradation values of red (R), green (G) and blue (B) are essentially the same regardless of the voltage level, and the gradation value-voltage curves in FIG. 3 show approximately the same trajectory for the respective colors. Meanwhile, as shown in FIG. 4, on the light exit side of the liquid crystal display panel, even at the same gradation value, voltages applied to liquid crystal are adjusted so that the size of voltages applied is in the order of red (R)<green (G)<blue (B). Therefore, a voltage applied to liquid crystal through a blue pixel electrode increases more than voltages applied to liquid crystal through pixel electrode of other colors. Therefore, because a value obtained by subtracting a voltage applied to liquid crystal through a blue pixel electrode constituting the light entry side pixel electrode group from a voltage applied to liquid crystal through a blue pixel electrode constituting the light exit side pixel electrode group is larger than a value obtained by subtracting a voltage applied to liquid crystal through a green pixel electrode constituting the light entry side pixel electrode group from a voltage applied to liquid crystal through a green pixel electrode constituting the light exit side pixel electrode group, and is larger than a value obtained by subtracting a voltage applied to liquid crystal through a red pixel electrode constituting the light entry side pixel electrode group from a voltage applied to liquid crystal through a red pixel electrode constituting the light exit side pixel electrode group, blue is enhanced on the light exit side. Furthermore, the gradation value-voltage curves in FIG. 4 show that differences between voltage values applied to liquid crystal through the respective colors become greater as a gradation value increases.

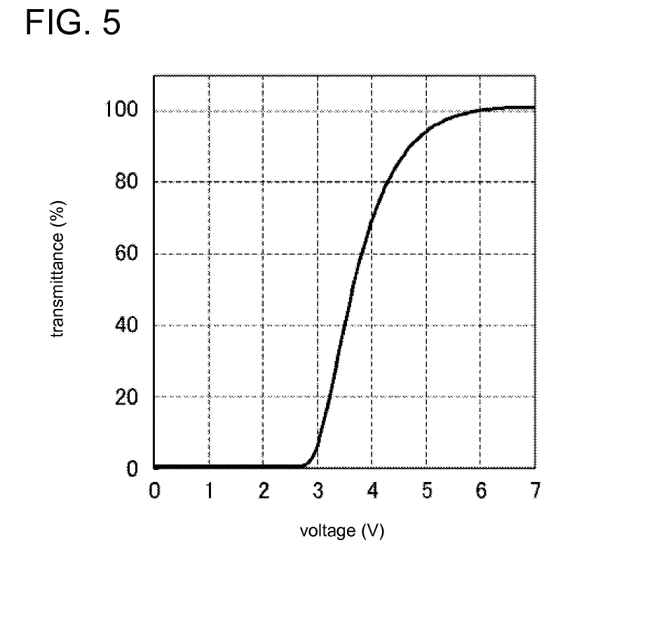

FIG. 5 is a graph showing the relation between voltages applied to liquid crystal and the transmittance of light through a liquid crystal display panel in a normally black liquid crystal display device. As shown in FIG. 5, in a normally black liquid crystal display device, the voltage-transmittance (V-t) curve shows that transmittance of light through the liquid crystal display panel becomes greater as a voltage applied to liquid crystal increases. In Embodiment 1, yellow tinges in an area of the LCD display unit far from the light source are suppressed by enhancing blue light, which is the complementary color of yellow, using this characteristic, and colors are displayed evenly in any area of the display panel.

In Embodiment 1, voltages are applied in different amounts to liquid crystal through the respective pixel electrodes so that the voltages applied to liquid crystal through the respective pixel electrodes constituting a set of pixel electrode group closer to the light source are essentially the same for the red (R), green (G) and blue (B) pixel electrodes, and that the voltages applied to liquid crystal through the respective pixel electrodes constituting a set of pixel electrode group farther from the light source are in the order of blue (B), green (G) and red (R) pixel electrodes (blue (B)>green (G)>red (R)). A specific method for adjusting voltages applied to liquid crystal through the respective red (R), green (G) and blue (B) pixel electrodes is explained below in detail.

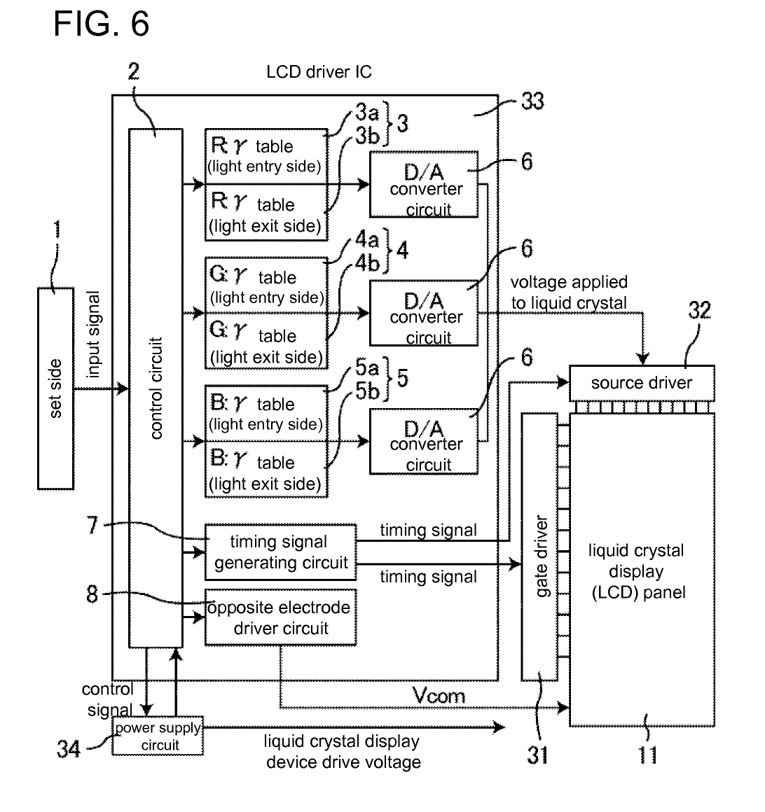

FIG. 6 is a block diagram showing signal processing performed by a peripheral circuit of the liquid crystal display device according to Embodiment 1. As shown in FIG. 6, a storage medium for storing three γ tables for pixel electrodes of the respective colors, that is, a red (R) γ table 3, a green (G) γ table 4 and a blue (B) γ table 5, is provided in the peripheral circuit. Furthermore, in Embodiment 1, a plurality of γ tables are provided for each of the γ tables 3, 4 and 5, and each has different data depending on the distance from the light source. More specifically, in Embodiment 1, for each color, two γ tables, which are a light entry side γ table for controlling voltages applied to liquid crystal on the light entry side and a light exit side γ table for controlling voltages applied to liquid crystal on the light exit side, are provided. The red (R) γ table 3 is divided into a light entry side γ table 3a and a light exit side γ table 3b. The green (G) γ table 4 is divided into a light entry side γ table 4a and a light exit side γ table 4b. The blue (B) γ table 5 is divided into a light entry side γ table 5a and a light exit side γ table 5b. The aforementioned FIGS. 3 and 4 are data tables compiling these.

By providing two γ tables, that is, a light entry side γ table and a light exit side γ table, as in Embodiment 1, the voltage applied to liquid crystal can be appropriately adjusted in an area located between the areas on the light entry side and the light exit side (hereinafter also referred to as a middle area) as well as in the areas on the light entry side and the light exit side. Specifically, data of voltages that should be applied to liquid crystal in the middle area can be calculated using data of liquid crystal applied voltages set in the light entry side γ table and data of liquid crystal applied voltages set in the light exit side γ table by linear interpolation of these data with a linear function (straight line). For example, in an area located halfway between the light entry side and the light exit side, an average between the data of liquid crystal applied voltages set in the light entry side γ table and the data of liquid crystal applied voltages set in the light exit side γ table can be used.

Furthermore, as shown in FIG. 5, the V-t curve varies in a curved manner. Because of this, a linear interpolation with a straight line may seem inappropriate. However, as shown in FIGS. 3 and 4, there is no major difference in voltage that should be applied to liquid crystal through pixel electrodes of respective colors between the light entry side and the light exit side, and the linearly interpolated range is merely a part of the whole curve in FIG. 5. Therefore, the voltage that should be applied to liquid crystal in the middle area can be calculated from the linearly approximated voltage-transmittance curve. Therefore, according to Embodiment 1, voltages applied to liquid crystal can be appropriately set for the overall LCD panel with a minimum storage area, and excellent display having uniformity over the entire display area can be obtained. Here, the inclination of the V-t curve varies depending on the liquid crystal material used in the liquid crystal layer. In Embodiment 1, chromaticity inclination can be calculated appropriately based on the inclination of the V-t curve.

Other structures in the peripheral circuit of the liquid crystal display device of Embodiment 1 are explained with reference to FIG. 6. As shown in FIG. 6, the liquid crystal display device of Embodiment 1 has an LCD panel 11, and the LCD panel 11, as described above, is constituted of a display unit having a plurality of electrodes therein and a peripheral circuit unit for controllably driving the display unit.

In the peripheral circuit unit, a set side 1, a gate driver 31, a source driver 32, an LCD driver IC (Integrated Circuit) 33, and a power supply circuit (power supply) 34 are formed.

The liquid crystal display device of Embodiment 1 has a main MPU (Micro Processing Unit) as the set side 1 to the peripheral circuit unit of the LCD panel 11. The main MPU outputs various signals (input signals) such as horizontal synchronization signals and image signals and the like into a control circuit 2.

In the display unit, one of the substrates of the LCD panel has a plurality of scan signal lines that are parallel to each other, a plurality of data signal lines that are parallel to each other, pixel electrodes surrounded by two adjacent scan signal lines and two adjacent data signal lines, and switching elements arranged on intersections of scan signal lines and data signal lines. Therefore, pixel electrodes are arranged in a matrix. As the switching elements, TFTs (Thin Film Transistors) can be used, for example. In addition, these components can be provided on different layers with an insulating film between them so that they are not electrically connected to each other.

The gate driver 31 successively generates scan signals sent to scan signal lines connected to each pixel electrode based on timing signals such as a gate clock signal (GCK) and a gate start pulse (GSP) and the like outputted from the LCD driver IC 33. The source driver 32 samples display data (DAT) displayed in a voltage applied to liquid crystal outputted from the LCD driver IC 33 based on timing signals such as a source clock signal (SCK), a source start pulse (SSP) and the like also outputted from the LCD driver IC 33, and outputs the resultant image data into the data signal lines connected to respective pixel electrodes.

The LCD driver IC 33 is equipped with a memory onto which the γ tables 3, 4 and 5 for display data are written, D/A converter circuits 6 disposed at a stage following the γ tables 3, 4 and 5, respectively, a control circuit 2 for controlling the entirety of the LCD driver IC 33, a timing signal generating circuit 7, and an opposite electrode driver circuit 8.

The opposite electrode driver circuit 8 applies an opposite voltage (Vcom) to the opposite electrode arranged to face the pixel electrodes. The timing signal generating circuit 7 outputs timing signals such as a gate clock signal (GCK), a gate start pulse (GSP) and the like into the gate driver 31, and outputs timing signals such as a source clock signal (SCK), a source start pulse (SSP) and the like into the source driver 32.

The γ table includes the R-γ table 3, the G-γ table 4 and the B-γ table 5, and for each color, there are two types of γ tables for the light entry side and the light exit side. Furthermore, in the LCD driver IC 33, data for performing a linear interpolation using these two types of γ tables are included. Accordingly, the respective γ tables convert (γ correction) image signals obtained from the set side into appropriate voltage signals for the gamma characteristics (relation between the input level of signals and the distance from the light source) of the liquid crystal panel, and output various signals. In Embodiment 1, separate γ tables are provided independently for the respective colors of red, green and blue. Therefore, voltages applied to liquid crystal can be adjusted appropriately for the respective colors. In addition, because the voltage that should be applied to liquid crystal in the middle area between the light entry side and the light exit side is linearly interpolated using these two types of γ tables, appropriate voltages can be applied to liquid crystal not only on the light entry side and the light exit side, but also in the middle area between these two sides.

D/A converter circuits 9 as shown in FIG. 6, are provided for the R-γ table 3, the G-γ table 4 and the B-γ table 5 respectively, and generates voltages applied to liquid crystal by converting voltage signals outputted from the γ tables 3, 4 and 5 from digital to analog data, and outputs the voltages applied to liquid crystal into the source driver 32.

Power is supplied to the power supply circuit 34 from the set side 1. The power supply circuit 34 receives a control signal from the control circuit 2, and supplies power to each circuit of the liquid crystal display device. Accordingly, the power supply circuit 34 applies liquid crystal display device driving voltages to the gate driver 31, the source driver 32 and the like.

A method for generating the respective γ tables 3, 4 and 5 provided in the liquid crystal display device of Embodiment 1 and a methodology for applying appropriate voltages to liquid crystal in each area of the LCD panel based on the respective γ tables 3, 4 and 5 are explained below. First, for light entry side γ tables, γ tables that are adjusted so that voltages applied to liquid crystal are essentially the same for the pixel electrodes of the respective colors are provided. Next, in order to generate γ tables for the light exit side, actual chromaticity is first measured in order to check the degree of chromaticity shift, which depends on the distance from the light source. To measure the chromaticity, an LCD panel for testing is prepared. Then, while the LCD panel displays white, the chromaticity of light transmitted through an area where a pixel electrode group closer to the light source is located and the chromaticity of light transmitted through an area where a pixel electrode group farther from the light source is located are specifically measured using a spectroradiometer (product name: SR-3, made by TOPCON Technohouse Corporation), for example.

Then, as the light exit side γ tables, with respect to the area where voltages applied to liquid crystal are to be adjusted at different levels for the respective colors—i.e., the area where pixel electrode group farther from the light source is located, red, green and blue γ tables are generated and stored in a memory (storage medium) so that liquid crystal applied voltages that correct the chromaticity shift between the area where pixel electrode groups closer to the light source are located and the area where pixel electrode groups farther from the light source are located are generated based on the data obtained by performing the aforementioned chromaticity measurements. Accordingly, light entry side and light exit side γ tables that take into account the distance from the light source are generated.

Then, based on the light entry side and light exit side γ tables, voltages that need to be applied to liquid crystal through the respective pixel electrodes located in the middle area are calculated by a linear interpolation. More specifically, a value of voltage applied to liquid crystal obtained in the light entry side γ table and a value of voltage applied to liquid crystal obtained in the light exit side γ table are identified for each color, and a chromaticity inclination based on the distance from the light source is obtained. Here, the aforementioned chromaticity inclination may be approximately calculated using a linear function (straight line). Based on the data obtained in this way, appropriate voltages are applied through the respective pixel electrode groups to the respective areas.

Accordingly, in all pixel electrode groups in the area between the light entry side pixel electrode groups and the light exit side pixel electrode groups, the chromaticity inclination based on voltages applied to liquid crystal and the chromaticity inclination based on the distance from the light source (optical path length of light passing in a light guide plate) offset each other, and excellent display having chromaticity uniformity on the LCD panel can be obtained. Furthermore, in Embodiment 1, voltages applied to liquid crystal, which are generated at different values for the respective areas, can be detected and verified by signal waveforms outputted from the LCD driver IC 33.

FIGS. 3 and 4 are both γ table data obtained by actually measuring chromaticity in the respective areas on the light entry side and the light exit side. In fact, FIG. 3 shows a graph showing light entry side γ tables generated from the closest set of pixel electrode group to the light source, and FIG. 4 shows a graph showing light exit side γ tables generated from the farthest set of pixel electrode group from the light source. In order to generate these γ tables, a normally black mode liquid crystal display device was used. The chromaticity of light that has been transmitted through an area including the closest set of pixel electrode group to the light source and the chromaticity of light that has been transmitted through an area including the farthest set of pixel electrode group from the light source were measured using a spectroradiometer (product name: SR-3, made by TOPCON Technohouse Corporation).

### Embodiment 2

A liquid crystal display device according to Embodiment 2 is a first liquid crystal display device of the present invention that is normally black. The liquid crystal display device of Embodiment 2 is different from the liquid crystal display device of Embodiment 1 in that a light source is provided not only on one side of the light guide plate, but also on the other side that faces the first side through the light guide plate. However, it is similar to Embodiment 1 in other respects.

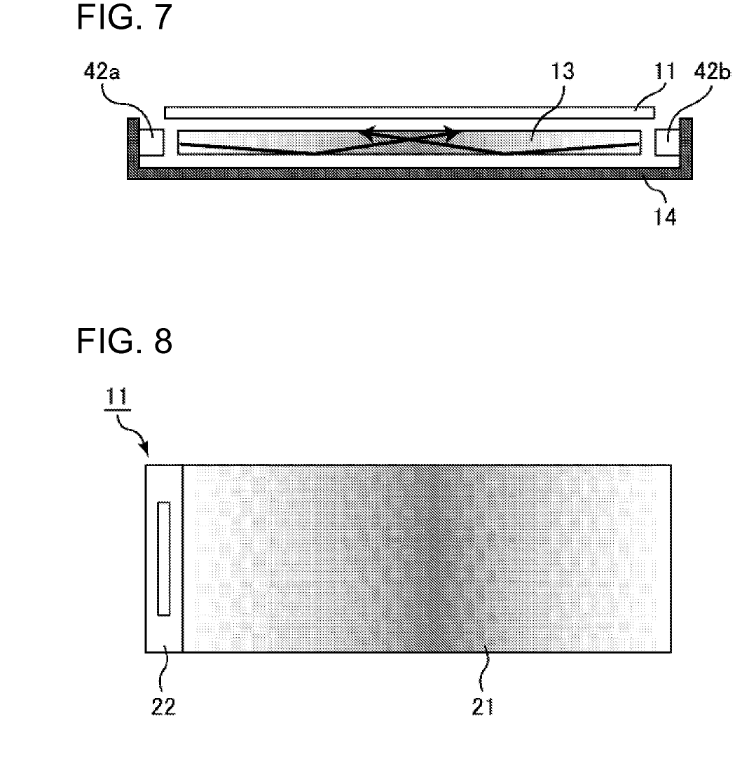

FIG. 7 is a cross-sectional schematic view of the liquid crystal display device according to Embodiment 2. As shown in FIG. 7, in the liquid crystal display device of Embodiment 2, an LCD panel 11 and a light guide plate 13 are arranged to overlap each other. A first light source 42a is provided on one side of the light guide plate 13 and a second light source 42b is provided on the other side of the light guide plate 13, facing each other. Light (black arrow) emitted from the first light source 42a and the second light source 42b respectively enters the light guide plate 13 from sides of the light guide plate 13, and due to a structural pattern provided on the light guide plate 13, is reflected, refracted or diffused, and is emitted as planar light from the main surface side of the light guide plate 13 towards the liquid crystal display panel 11.

FIG. 8 is a schematic plan view of the LCD panel provided in the liquid crystal display device according to Embodiment 2. As shown in FIG. 8, the LCD panel 11 is constituted of a display unit 21 constituting a display screen and a peripheral circuit unit 22 for controllably driving the display unit 21. The first light source 42a is provided below a side of the LCD panel 11 on the side the peripheral circuit unit 22 is located, and the second light source 42b is provided below a side on the side opposite to the side on which the peripheral circuit unit 22 is located. Therefore, in Embodiment 2, the display unit 21 of the LCD panel is divided into two light entry side areas and a middle area.

As described above, because yellow tinges on the display occur linearly, it may seem that tinges on the LCD panel 11 would occur evenly as a whole with the configuration of Embodiment 2 having two light sources provided to face each other. However, in reality, because the light guide plate uses light from a closer light source, on the light entry side of the first light source 42a, the first light source 42a has a greater effect and yellow tinges are less likely to occur. On the other hand, on the light entry side of the second light source 42b, the second light source 42b has a greater effect and yellow tinges are less likely to occur. As a result, as shown in FIG. 8, the most intense yellow tinges occur in the middle area of the display unit 21.

Embodiment 2 focuses on this point, and controls yellow tinges on the overall display by differentiating voltages applied to liquid crystal through pixel electrodes constituting the pixel electrode group in the middle area and voltages applied to liquid crystal through pixel electrodes constituting the pixel electrode groups on the light entry sides.

In Embodiment 2, voltages are applied in different amounts to liquid crystal through the respective pixel electrodes so that the voltages applied to liquid crystal through the respective pixel electrodes constituting a set of pixel electrode group closer to the light source, namely, the pixel electrode group on the light entry side of the first light source 42a and the pixel electrode group on the light entry side of the second light source 42b, are essentially the same for the red (R), green (G) and blue (B) pixel electrodes, and that the voltages applied to liquid crystal through the respective pixel electrodes constituting a set of pixel electrode group farther from the light sources, namely, the pixel electrode groups in the middle, are in the order of blue (B), green (G) and red (R) pixel electrodes (blue (B)>green (G)>red (R)).

In Embodiment 2, voltages applied to liquid crystal are controlled in a manner similar to Embodiment 1 using a storage medium that stores three γ tables that are formed in a peripheral circuit unit for pixel electrodes of the respective colors, the three γ tables being a red (R) γ table, a green (G) γ table, and a blue (B) γ table. Each γ table has two tables: a light entry side γ table and a light exit side γ table.

Voltages applied to the respective pixel electrode groups located between the pixel electrode groups in the middle and the pixel electrode groups on the light entry side of the first light source 42a are values obtained by a linear interpolation from voltages applied to pixel electrodes constituting the pixel electrode group in the middle and voltages applied to pixel electrodes constituting the pixel electrode group on the light entry side of the first light source 42a. Similarly, voltages applied to the respective pixel electrode groups located between the pixel electrode group in the middle and the pixel electrode group on the light entry side of the second light source 42b are values obtained by a linear interpolation from voltages applied to pixel electrodes constituting the pixel electrode group in the middle and voltages applied to pixel electrodes constituting the pixel electrode group on the light entry side of the second light source 42b.

Accordingly, in all pixel electrode groups in the area between the light entry side pixel electrode group and the pixel electrode group in the middle, the chromaticity inclination based on a voltage applied to liquid crystal and the chromaticity inclination based on the distance from the light source (optical path length of light passing in a light guide plate) offset each other, and excellent display having chromaticity uniformity can be obtained on the LCD panel 11. In Embodiment 2, voltages applied to liquid crystal, which are generated at different values for the respective areas, can be detected and verified by signal waveforms outputted from the LCD driver IC 33.

### Embodiment 3

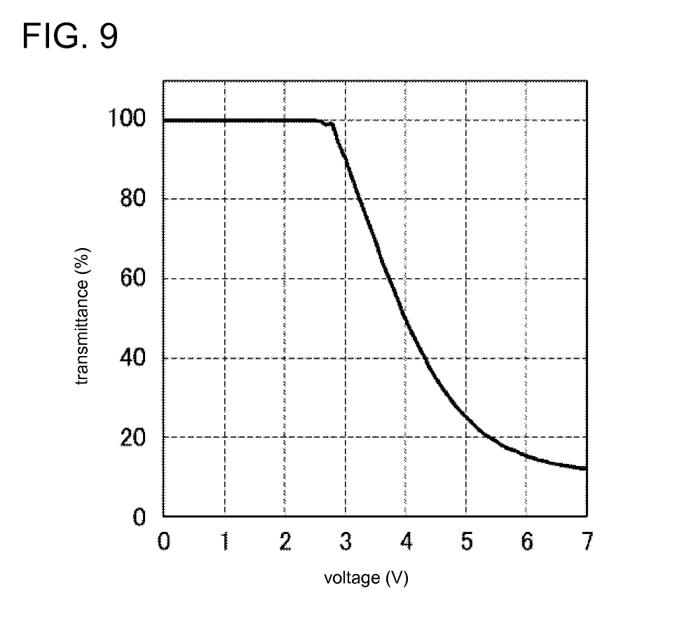

A liquid crystal display device according to Embodiment 3 is a second liquid crystal display device of the present invention that is normally white. The liquid crystal display device of Embodiment 3 is different from Embodiment 1 in terms of being normally white as well as voltages applied to liquid crystal being controlled differently. However, it is similar to Embodiment 1 in other respects. FIG. 9 is a graph showing the relation between voltages applied to liquid crystal and the transmittance of light through a liquid crystal display panel in a normally white liquid crystal display device. As shown in FIG. 9, in a normally white liquid crystal display device, the voltage-transmittance (V-t) curve shows that the transmittance of light through the liquid crystal display panel decreases as the voltage applied to liquid crystal increases. In Embodiment 3, yellow tinges in areas of an LCD display unit far from the light source are suppressed by enhancing blue light, which is the complementary color of yellow, using this characteristic, and colors are displayed uniformly in any area of the display panel.

In a manner similar to the liquid crystal display device of Embodiment 1, in the liquid crystal display device of Embodiment 3, on each substrate of the aforementioned pair of substrates, a polarizing plate is arranged on the opposite side from the liquid crystal layer side, thereby forming a pair of polarizing plates facing each other. On the polarizing plates, a retardation film, such as a λ/4 plate, λ/2 plate or the like, may be attached as needed. The liquid crystal display device can be normally white in a VA mode, an IPS mode or the like by adjusting polarizing axes that are provided respectively in the aforementioned pair of polarizing plates to be parallel to each other (parallel Nicols state). Furthermore, the liquid crystal display device can be normally white in a TN mode by adjusting the polarizing axes that are provided respectively in the aforementioned pair of polarizing plates to form a right angle to each other (crossed Nicols state).

In Embodiment 3, voltages are applied in different amounts to liquid crystal through the respective pixel electrodes so that the voltages applied to liquid crystal through the respective pixel electrodes constituting a set of pixel electrode group closer to the light source are essentially the same for the red (R), green (G) and blue (B) pixel electrodes, and that the voltages applied to liquid crystal through the respective pixel electrodes constituting a set of pixel electrode group farther from the light source are in the order of red (R), green (G) and blue (B) pixel electrodes (red (R)>green (G)>blue (B)).

Therefore, the voltage applied to liquid crystal through a blue pixel electrode decreases more than voltages applied to liquid crystal through pixel electrodes of other colors. In other words, because the value obtained by subtracting a voltage applied to liquid crystal through a blue pixel electrode constituting the light entry side pixel electrode group from a voltage applied to liquid crystal through a blue pixel electrode constituting the light exit side pixel electrode group is smaller than a value obtained by subtracting a voltage applied to liquid crystal through a green pixel electrode constituting the light entry side pixel electrode group from a voltage applied to liquid crystal through a green pixel electrode constituting the light exit side pixel electrode group, and is smaller than a value obtained by subtracting a voltage applied to liquid crystal through a red pixel electrode constituting the light entry side pixel electrode group from a voltage applied to liquid crystal through a red pixel electrode constituting the light exit side pixel electrode group, blue is enhanced on the light exit side.

In Embodiment 3, the voltages applied to liquid crystal are controlled in a manner similar to Embodiment 1 using a storage medium that stores three γ tables that are formed in a peripheral circuit unit for each pixel electrode of the respective colors. The three γ tables are a red (R) γ table 3, a green (G) γ table 4 and a blue (B) γ table 5. The γ tables 3, 4 and 5 are respectively provided with a light entry side γ table and a light exit side γ table as in Embodiment 1.

Voltages applied to the respective pixel electrode groups located between the light entry side pixel electrode groups and the light exit side pixel electrode groups are values obtained by a linear interpolation from voltages applied to pixel electrodes constituting the light entry side pixel electrode group and voltages applied to pixel electrodes constituting the light exit side pixel electrode group.

Accordingly, in all pixel electrode groups in the area between the light entry side pixel electrode group and the light exit side pixel electrode group, the chromaticity inclination based on voltages applied to liquid crystal and the chromaticity inclination based on the distance from the light source (optical path length of light passing in the light guide plate) offset each other, and excellent display having chromaticity uniformity can be obtained on the LCD panel. Furthermore, in Embodiment 3, voltages applied to liquid crystal, which are generated at different values for the respective areas, can be detected and verified by signal waveforms outputted from the LCD driver IC.

### Embodiment 4

A liquid crystal display device according to Embodiment 4 is a first liquid crystal display device of the present invention that is normally white. As in the liquid crystal display device of Embodiment 2, the liquid crystal display device of Embodiment 4 is different from the liquid crystal display device of Embodiment 3 in that a light source is provided not only on one side of the light guide plate, but also on the side opposite thereto through the light guide plate. However, it is similar to Embodiment 3 in other respects.

In Embodiment 4, yellow tinges on the overall display are controlled by differentiating voltages applied to liquid crystal through pixel electrodes constituting the pixel electrode group in the middle and voltages applied to liquid crystal through pixel electrodes constituting the pixel electrode group on the light entry side.

In Embodiment 4, voltages are applied in different amounts to liquid crystal through the respective pixel electrodes so that the voltages applied to liquid crystal through the respective pixel electrodes constituting a set of pixel electrode group closer to the light source, namely, the pixel electrode group on the light entry side of the first light source and the pixel electrode groups on the light entry side of the second light source, are essentially the same for the red (R), green (G) and blue (B) pixel electrodes, and that the voltages applied to liquid crystal through the respective pixel electrodes constituting a set of pixel electrode group farther from the light source, namely, the pixel electrode group located in the middle, are in the order of blue (B), green (G) and red (R) pixel electrodes (red (R)>green (G)>blue (B)).

In Embodiment 4, the voltage applied to liquid crystal is controlled in a manner similar to Embodiment 3 using a storage medium that stores three γ tables that are formed in a peripheral circuit unit for each pixel electrode of the respective colors. The three γ tables are a red (R) γ table, a green (G) γ table and a blue (B) γ table. Each γ table is provided with a light entry side γ table and a light exit side γ table.

The voltages applied to the respective pixel electrode groups located between the pixel electrode group in the middle and the pixel electrode group on the light entry side of the first light source are values obtained by a linear interpolation from voltages applied to pixel electrodes constituting the pixel electrode group in the middle and voltages applied to pixel electrodes constituting the pixel electrode group on the light entry side of the first light source. Similarly, the voltages applied to the respective pixel electrode groups located between the pixel electrode group located in the middle and the pixel electrode group on the light entry side of the second light source are values obtained by a linear interpolation from voltages applied to pixel electrodes constituting the pixel electrode group in the middle and voltages applied to pixel electrodes constituting the pixel electrode group on the light entry side of the second light source.

Accordingly, in all pixel electrode groups in the area between the light entry side pixel electrode group and the light exit side pixel electrode group, the chromaticity inclination based on the voltage applied to liquid crystal and the chromaticity inclination based on the distance from the light source (optical path length of light passing in a light guide plate) offset each other, and excellent display having chromaticity uniformity can be obtained on the LCD panel. Furthermore, in Embodiment 4, voltages applied to liquid crystal, which are generated at different values for the respective areas, can be detected and verified by signal waveforms outputted from the LCD driver IC.

The present application claims priority to Patent Application No. 2009-025294 filed in Japan on Feb. 5, 2009 under the Paris Convention and provisions of national law in designated States. The entire contents of which are hereby incorporated by reference.

### DESCRIPTION OF REFERENCE CHARACTERS

1 set side
2 control circuit
3 R-γ table
3a R-γ table (light entry side)
3b R-γ table (light exit side)
G-γ table
4a G-γ table (light entry side)
4b G-γ table (light exit side)
5 B-γ table
5a B-γ table (light entry side)
5b B-γ table (light exit side)
6 D/A converter circuit
7 timing signal generating circuit
8 opposite electrode driver circuit
11 liquid crystal display (LCD) panel
12 light source
13 light guide plate
14 frame
21 display unit
22 peripheral circuit unit
31 gate driver
32 source driver
33 LCD driver IC
34 power supply circuit
42a first light source
42b second light source

1. A normally black liquid crystal display device, comprising:
a liquid crystal display panel provided with two or more sets of pixel electrode groups each comprising a red pixel electrode, a green pixel electrode, and a blue pixel electrode;
a light guide plate arranged to overlap the liquid crystal display panel; and
a light source arranged on a side of the light guide plate along one side thereof,
wherein, of said two or more sets of pixel electrode groups, a value obtained by subtracting a voltage applied to liquid crystal through a blue pixel electrode in a set of pixel electrode group closer to the light source from a voltage applied to liquid crystal through a blue pixel electrode in a set of pixel electrode group farther from the light source is larger than a value obtained by subtracting a voltage applied to liquid crystal through a green pixel electrode in the set of pixel electrode group closer to the light source from a voltage applied to liquid crystal through a green pixel electrode in the set of pixel electrode group farther from the light source, and is larger than a value obtained by subtracting a voltage applied to liquid crystal through a red pixel electrode in the set of pixel electrode group closer to the light source from a voltage applied to liquid crystal through a red pixel electrode in the set of pixel electrode group farther from the light source.

2. A normally white liquid crystal display device, comprising:
a liquid crystal display panel provided with two or more sets of pixel electrode groups each comprising a red pixel electrode, a green pixel electrode, and a blue pixel electrode;
a light guide plate arranged to overlap the liquid crystal display panel; and
a light source arranged on a side of the light guide plate along one side thereof,
wherein, of said two or more sets of pixel electrode groups, a value obtained by subtracting a voltage applied to liquid crystal through a blue pixel electrode in a set of pixel electrode group closer to the light source from a voltage applied to liquid crystal through a blue pixel electrode in a set of pixel electrode group farther from the light source is smaller than a value obtained by subtracting a voltage applied to liquid crystal through a green pixel electrode in the set of pixel electrode group closer to the light source from a voltage applied to liquid crystal through a green pixel electrode in the set of pixel electrode group farther from the light source, and is smaller than a value obtained by subtracting a voltage applied to liquid crystal through a red pixel electrode in the set of pixel electrode group closer to the light source from a voltage applied to liquid crystal through a red pixel electrode in the set of pixel electrode group farther from the light source.

3. The liquid crystal display device according to claim 1, wherein said set of pixel electrode groups closer to the light source is the closest set of pixel electrode groups to the light source and said set of pixel electrode group farther from the light source is the farthest set of pixel electrode groups from the light source.

4. The liquid crystal display device according to claim 1, further comprising a peripheral circuit for driving a liquid crystal display panel,
wherein said peripheral circuit includes a storage medium having a plurality of γ tables including a first γ table for controlling voltages applied to liquid crystal through respective pixel electrodes in the set of pixel electrode group closer to the light source and a second γ table for controlling voltages applied to liquid crystal through respective pixel electrodes in the set of pixel electrode group farther from the light source.

5. The liquid crystal display device according to claim 4, wherein said plurality of γ tables are only the first and second γ tables.

6. The liquid crystal display device according to claim 4, wherein voltages applied to liquid crystal through respective pixel electrodes in a middle pixel electrode group located between said set of pixel electrode group closer to the light source and said set of pixel electrode group farther from the light source are calculated by a linear interpolation from the first and second γ tables.
